(19) United States
(12) Patent Application Publication
(10) Pub. No.: US 2019/0199595 A1
(43) Pub. Date: Jun. 27, 2019

(54) ATTRIBUTE AND PROPERTY OVERRIDES FOR REMOTE NETWORK TOPOLOGY CHANGES

(71) Applicant: Avaya Inc., Santa Clara, CA (US)

(72) Inventors: Robert E. Braudes, Erie, CO (US); Amit Mishra, Broomfield, CO (US); Kurt Haserodt, Westminster, CO (US)

(21) Appl. No.: 15/851,940

(22) Filed: Dec. 22, 2017

(51) Int. Cl. H04L 12/24

(52) U.S. Cl. CPC H04L 41/12; H04L 41/0863; H04L 41/0816

(57) ABSTRACT

Configuring a network topology can be a resource-intensive task. Services that may be “snapped-in” to a particular network often require physical alternations to the topology of the network. The topology may be remotely altered by providing an override datum to a configuration device such that a seed value for a datum is replaced and, as a result, the topology of the network altered to provide a particular service. As a benefit, one or more networks may have their physical topology remotely reconfigured with a single alteration of a datum.

### FIELD OF THE DISCLOSURE

The invention relates generally to systems and methods for network configuration and particularly to remove topology alterations.

### BACKGROUND

Computer networks, including telephony networks, require installation and often alteration in order to provide the services desired. Components and services often utilize dynamic values for a particular implementation. These dynamic values are accessed locally to the components and services which, if changed from a default value, require each local storage to have their respective values changed. For example, a voicemail server may provide 64 ports to enable 64 simultaneous connections to engage in services provided by the voicemail server. Attachment of additional ports, such as to enable 128 simultaneous connections, requires the local memory of the voicemail server to be accessed and reconfigured to enable the additional ports. While effective, such a methodology may be time consuming and induce errors and, especially with multiple and/or remote installations, such as in grid or cluster computing implementations, resource intensive.

### SUMMARY

These and other needs are addressed by the various embodiments and configurations of the present invention. The present invention can provide a number of advantages depending on the particular configuration. These and other advantages will be apparent from the disclosure of the invention(s) contained herein.

The embodiments disclosed herein solve several problems. With respect to certain embodiments herein, simplification of installation and administration of information systems is provided. Mechanisms are provided to unify applications that were independently developed. The invention also allows these disparate applications to appear consistent to the system administrator.

In another embodiment, an administrator may set a value in one place and have it pushed to multiple applications, that can be scoped at multiple levels.

In another embodiment, an application writer and/or system administrator may indicate that specified attributes or properties of independent applications should be logically linked, and to specify the values(s) to be assigned to these attributes or properties. These values may be directly specified, or a transformation may be provided to be applied to the specified values. The transformations may run the gamut from simple, such as if the value specified is “x” to use value “y” in a linked application, to providing a complex algorithm for the transformation. As a benefit, this gives greater flexibility to the administrator in aligning the attributes and property values across different components and/or applications.

By providing a linkage between applications to be independently specified from the application development process, asynchronous development of applications is enabled. Applications that were developed without knowledge of each or without a common standard or other guidance can now be implemented and have one application's data synchronized for use by another application in a simplex, duplex, single-to-multi-application, and/or multi-to-multi application data exchange to form additional or alternative systems that may have not have been previously envisioned.

In another embodiment, validation of data values is provided. Validation may be applied to the various attributes and/or properties. Validation helps to prevent malformed data values that could cause downstream operational problems.

Specifying and maintaining the data may be integrated within an administration server or other hardware via a user interface. An administrator is provided with the flexibility to apply the override data at multiple scopes and/or levels, for example, the data may be set to override factory defaults, enterprise-specific data, all nodes in a cluster, groups of clusters; the overrides may even be applied across clusters, impacting the applications in independent systems. This may be particularly applicable to synchronize applications across geo-redundant systems.

In one embodiment, a system is disclosed, comprising: a processor comprising electrical circuitry; a data storage, accessible to the processor; a network interface, accessible to the processor and connecting the processor to a network; and wherein the processor: provides a telecommunication service for telecommunication devices on the network and is configured to provide the telecommunication service utilizing a configured network topology of the network and the topology of the network is determined, at least in part, to by a datum of the telecommunication service, the datum having a seed value; receiving, via the network interface, an override datum; after receiving the override datum, replacing the value of the datum with the value of the override datum and providing the telecommunications service utilizing the configured network topology of the network as determined by the present value of the datum.

In another embodiment, a system is disclosed, comprising: a processor; a data storage, accessible to the processor; a network interface, accessible to the processor and connecting the processor to a networked component; and wherein the processor remotely, via the network interface, configures a network of components, comprising: accessing the networked component, the network component configures a telecommunication service for telecommunication devices on the network and is configured to provide the telecommunication service utilizing a configured network topology of the network and the topology of the network is determined, at least in part, to by a datum of the telecommunication service, the datum having a seed value; and providing an override datum to the networked component whereby after receiving the override datum, the networked component replaces the value of the datum with the value of the override datum and thereby provides the telecommunications service utilizing the configured network topology of the network as determined by the present value of the datum.

In another embodiment, a method is disclosed, comprising: configuring a network determined by a topology, the topology being determined by a networked component, the networked component determining a telecommunications service provided by the network topology and, wherein the topology is determined by a datum having a seed value; providing, an override datum to the networked component; and upon receiving the override datum, replacing the value of the datum with the value of the override datum and providing the telecommunications service utilizing a reconfigured network topology of the network as determined by the present value of the datum.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a second system in accordance with embodiments of the present disclosure;

FIG. 3 depicts a third system in accordance with embodiments of the present disclosure;

FIG. 4 depicts a fourth system in accordance with embodiments of the present disclosure; and

FIG. 5 depicts a process in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices that may be shown in block diagram form, and are well known or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

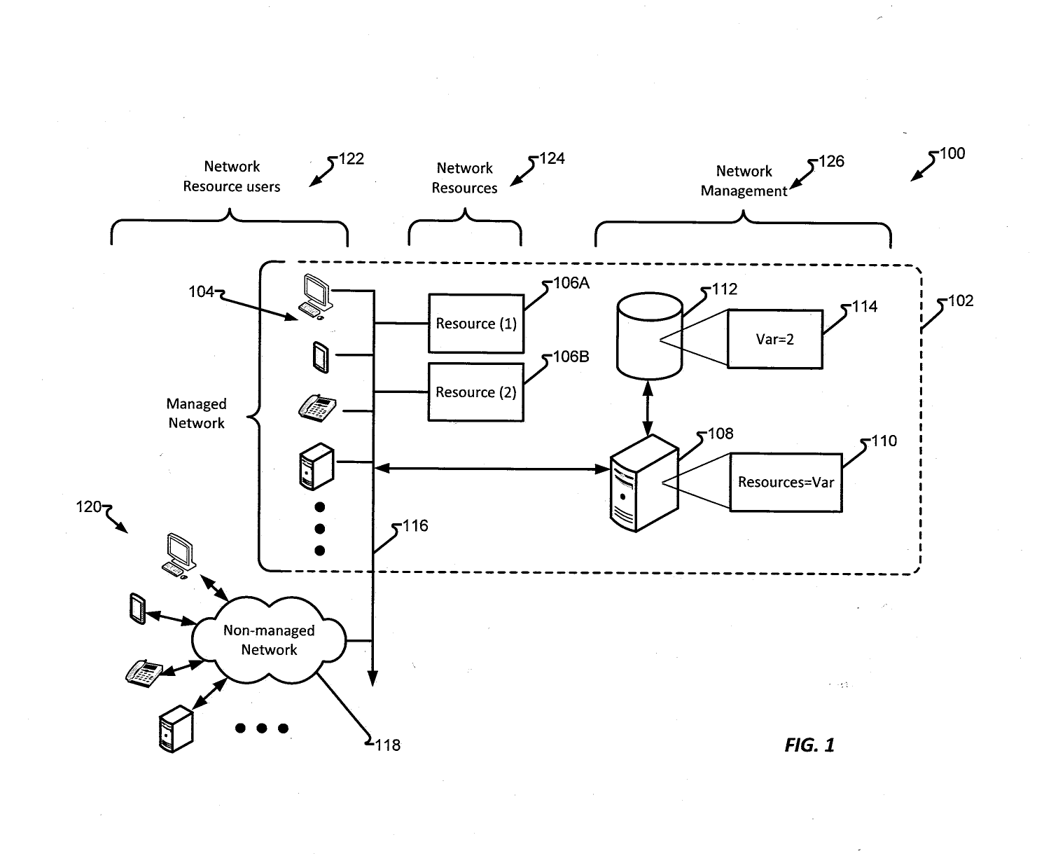

FIG. 1 depicts system 100 in accordance with embodiments of the present disclosure. In one embodiment, network 102 comprises components in a first topology. Network 102 may utilize attached components 104, which are “inside” network 102 and/or remote components 120, which are “outside” network 102. It should be appreciated that terms such as “inside” and “outside” may refer to trusted/untrusted components, components on one side, or the other side, of a firewall or other edge device, and/or components with a local address/non-local address of network 102. Network 102 may comprise internal communications component 116, such as a wired and/or wireless intranet and attached network 118, which may be a second private network, public network (e.g., Internet), public switched telephone network, etc. Attached components 104 and remote components 120 are, for embodiments described herein, network resource users 122. It should be appreciated that in other embodiments, such as one or more of attached components 104 may also provide network resources (e.g., be one of network resources 124), however, to avoid unnecessarily complicating the figures and description, network resource users 122 are considered as distinct from network resources 124.

Network resource 124 are variously embodied. Network resource 124 may provide one or more of data processing, data storage, connectivity, security, backup, redundancy, load balancing, and/or other service to network resource users 122 and/or other components of network 102. In one embodiment, network resources 124 comprise resources 106, which further comprise resource 106A and resource 106B. Resources 106 may be homogeneous, which each provide the same or similar service to network resource users 122 (e.g., all resources 106 are video conferencing servers) or heterogeneous, which at least one resource 106 provides a different service than at least one other resource 106 (e.g., resource 106A is a video conferencing server and resource 106B is a switch). In a further embodiment, heterogeneous resources may be distinct and functionally independent (e.g., resource 106A is a video conferencing server and resource 106B is a database) or functionally related (e.g., resource 106A is a voicemail server and resource 106B is a database storing voicemail recordings only or in addition to other data).

In another embodiment, configuration server 108 provides setup and/or management services to network 102. In a further embodiment, configuration server 108 provides configuration services to resources 106 and/or via resources 106. For example, configuration server 108 comprises a topology-determining variable 110 which may further be provided a value 114 from database 112. It should be appreciated that other processing/storing configurations are contemplated by the embodiments herein, such as when database 112 and/or other memory or storage, is provided by configuration server 108.

Configuration server 108 may utilize variable 110 to provide the first topology of network 102. Additionally, one or more resources 106 may also utilize a variable for their own processes. For example, resource 106A may be a voicemail server with “vm_port_count dynamically identifying the number of simultaneous voicemail ports available. Similarly, resource 106B may be a switch and be configured to provide “vm_port_count” number ports for voicemail purposes.

Configuration server 108 is illustrated as having memory 110 comprising a configuration attribute (“Resources”) having a value that is itself a variable (“Var”) and determined by the value determined in database 112 (“2”). In one embodiment, “2” may be a seed value to provide a non-null initial or default value.

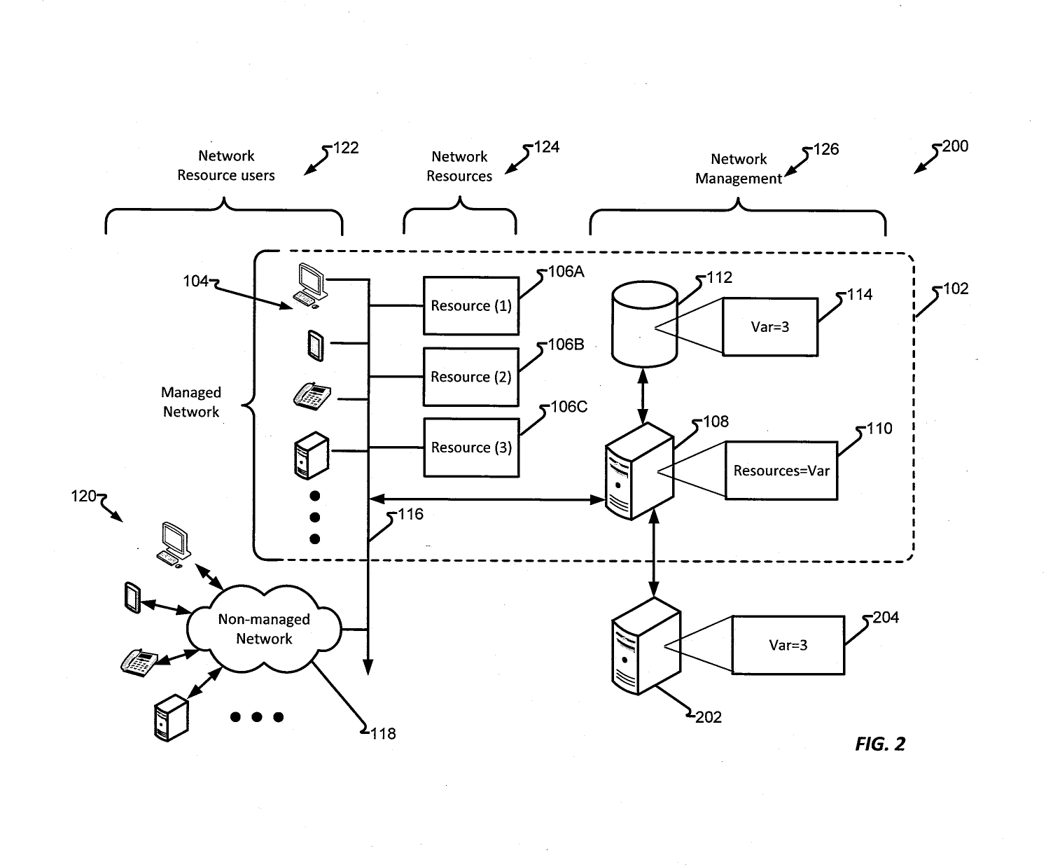

FIG. 2 depicts system 200 in accordance with embodiments of the present disclosure. In one embodiment, system 200 is a modification of system 100. In one embodiment, configuration server 108 is in communication with administration server 202, which may be performed via communication component 116 and/or other communications means. Administration server 202 comprises memory with override value 204. Upon providing override value 204 to configuration server 108, such as to replace value 114 in database 112, configuration server 108 modifies the topology of network 102, such as to add resource 106C to network resource 124 to be available to network resource users 122 and/or other components of network 102. Configuration server 108 may be unaltered, such as when the variable utilized is unchanged (e.g., “Resource=Var”) even though the underlying value has been altered (e.g., “Var=3”). As a benefit a remote administrator utilizing administration server 202 may alter the topology of network 102. Additionally, the altered topology of network 102, such as be the addition of resource 106C, may provide additional and/or alternative services. For example, resource 106C maybe a voicemail server when one or more of resources 106A, 106B are also voicemail servers or resource 106C may be an email server when neither of resources 106A, 106B are email servers.

The physical alteration of the topology may be provided via inclusion/exclusion of available components and/or the reconfiguration of components already attached. For example, resource 106C may have been available to network 102 but either not used or not enabled for use on network 102. Additionally, or alternatively, resource 106C may have been utilized for a first purpose but, upon receiving override value 204, reconfigured to provide a second purpose. Additionally, or alternatively, resource 106C may have been available to network resource users 122 but required a modification to one or more of resources 106A, 106B in order to utilize resource 106C. Accordingly, override value 204 may be provided to configuration server 108, such as via value 114 being updated in database 122, which provided to or accessed by the one or more of resources 106A, 106B. For example, resources 106A, 106B may distribute a tasks therebetween based on an internal storage for “Resources” (not shown), such as “2” indicating that two distributed resources are available for network resources 124. Upon being updated with override value 204, resources 106A, 106B are now aware of a third resource, resource 106C, and may now utilize the same. Such modifications are performed via application of override value 204 becoming value 114 and without modification to data storage of configuration server 108 or resources 106A, 106B.

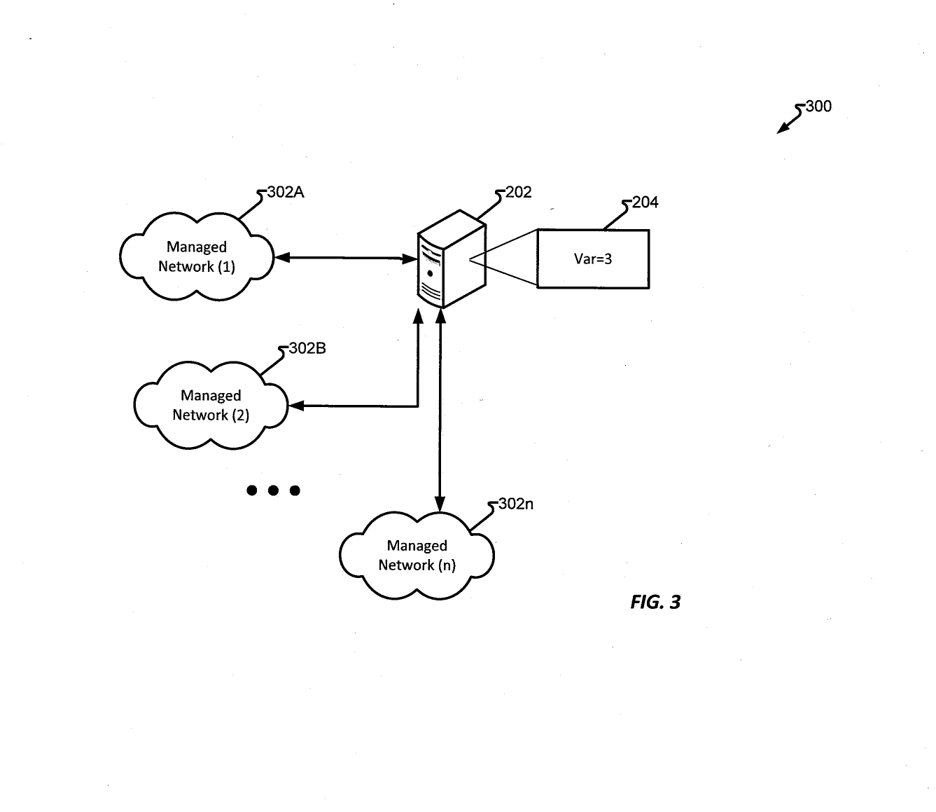

FIG. 3 depicts system 300 in accordance with embodiments of the present disclosure. In one embodiment, administration server 202, having override value 204, affects a topology change in a plurality of managed networks 302. Managed networks may be entirely isolated networks, nodes within a cluster, group of clusters, geo-redundant networks, etc.

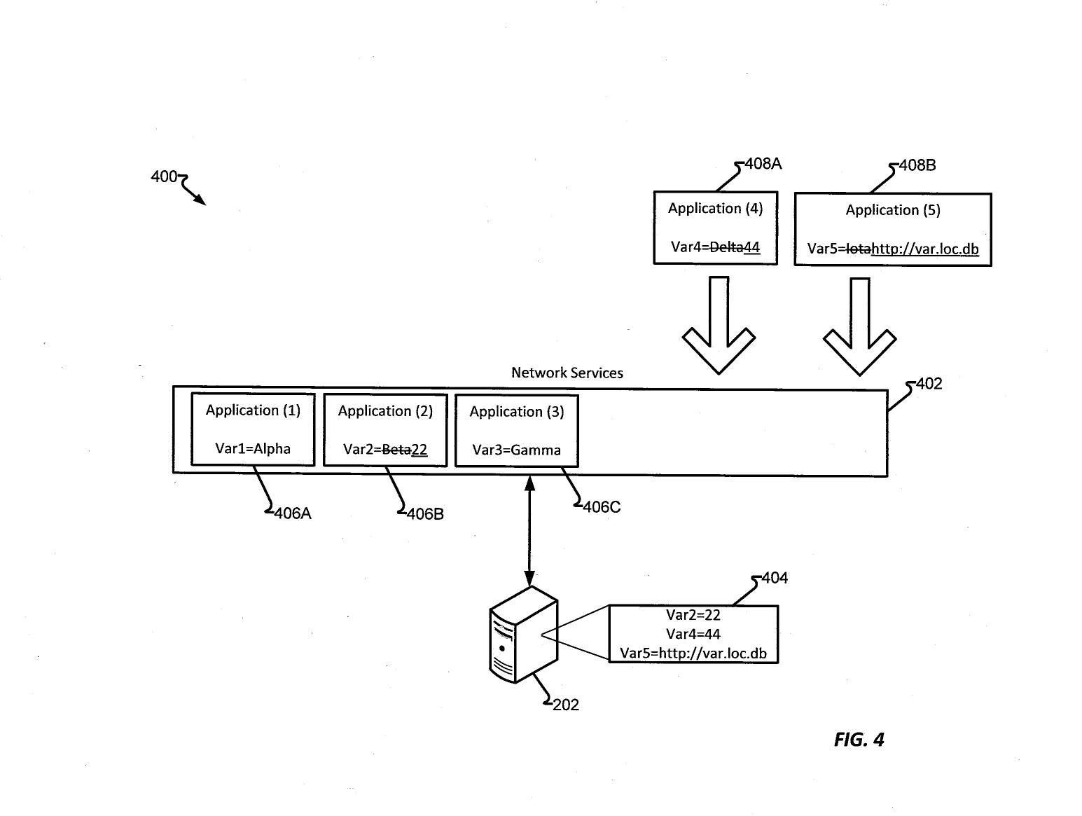

FIG. 4 depicts system 400 in accordance with embodiments of the present disclosure.

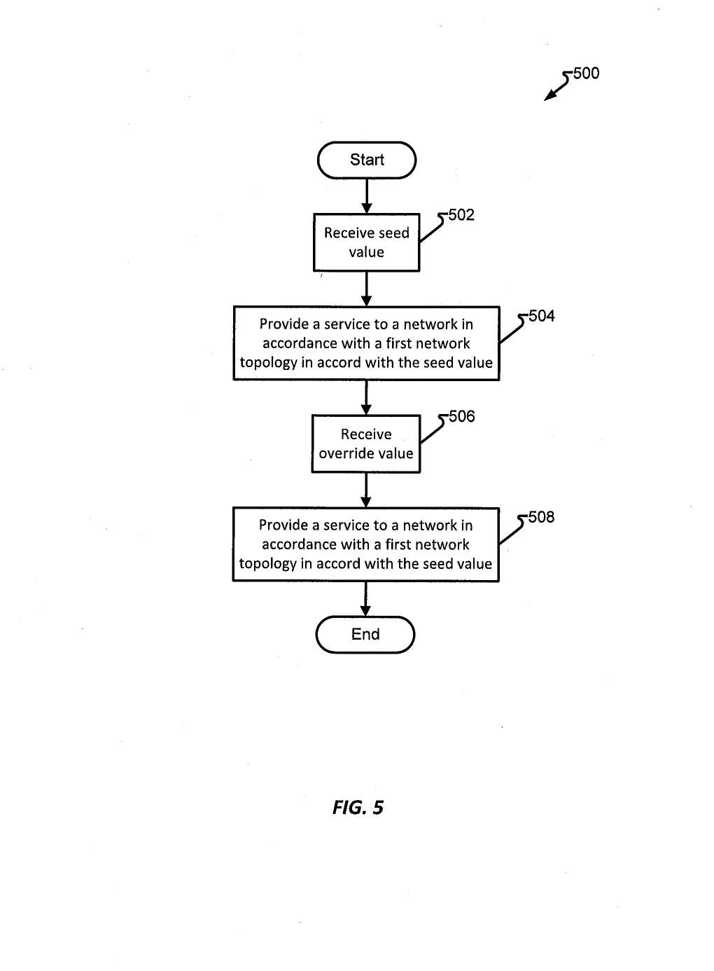

FIG. 5 depicts process 500 in accordance with embodiments of the present disclosure.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (e.g., GPU, CPU), or logic circuits programmed with the instructions to perform the methods (e.g., FPGA). In another embodiment, a processor may be a system or collection of processing hardware components, such as a processor on a client device and a processor on a server, a collection of devices with their respective processor, or a shared or remote processing service (e.g., “cloud” based processor). A system of processors may comprise task-specific allocation of processing tasks and/or shared or distributed processing tasks. In yet another embodiment, the processor is a first processor, comprised of a first set of hardware components, configured to provide the services of a second processor (e.g., an emulator) and whereby the hardware associated with the first processor may operate using an instruction set associated with a second processor.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., processors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a processor may comprise a first processor on one component and a second processor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system, comprising:
a processor comprising electrical circuitry;
a data storage, accessible to the processor;
a network interface, accessible to the processor and connecting the processor to a network; and
wherein the processor:
provides a telecommunication service for telecommunication devices on the network and is configured to provide the telecommunication service utilizing a configured network topology of the network and the topology of the network is determined, at least in part, to by a datum of the telecommunication service, the datum having a seed value;
receiving, via the network interface, an override datum;
after receiving the override datum, replacing the value of the datum with the value of the override datum and providing the telecommunications service utilizing the configured network topology of the network as determined by the present value of the datum.

2. The system of claim 1, wherein the datum defines a mode of operation to configure the network.

3. The system of claim 2, wherein the mode determines at least one of, memory allocation, media allocation, number of communication ports available on the network.

4. The system of claim 1, wherein:
the value of the override datum is an address to a remote value; and
wherein the processor, upon determining the override datum is an address, accesses the remote value and replaces the value of the datum with the remote value;

5. The system of claim 1, wherein value of the override datum is an attribute of the network topology.

6. The system of claim 5, wherein the attribute of the network topology comprises an attribute of a configured network topology prior to deployment of the configured network topology.

7. The system of claim 5, wherein the attribute of the network topology comprises an attribute of a reconfigured network topology prior to deployment of the reconfigured network topology.

8. The system of claim 1, further comprising, the processor providing the override datum to at least one other system.

9. The system of claim 1, wherein the processor reads a configuration script comprising the override datum.

10. A system, comprising:
a processor;
a data storage, accessible to the processor;
a network interface, accessible to the processor and connecting the processor to a networked component; and
wherein the processor remotely, via the network interface, configures a network of components, comprising:
accessing the networked component, the network component configures a telecommunication service for telecommunication devices on the network and is configured to provide the telecommunication service utilizing a configured network topology of the network and the topology of the network is determined, at least in part, to by a datum of the telecommunication service, the datum having a seed value; and
providing an override datum to the networked component whereby after receiving the override datum, the networked component replaces the value of the datum with the value of the override datum and thereby provides the telecommunications service utilizing the configured network topology of the network as determined by the present value of the datum.

11. The system of claim 10, wherein the datum defines a mode of operation to configure the network.

12. The system of claim 11, wherein the mode determines at least one of, memory allocation, media allocation, number of communication ports available on the network.

13. The system of claim 10, wherein:
the value of the override datum is an address to a remote value; and
wherein the networked component, upon determining the override datum is an address, accesses the remote value and replaces the value of the datum with the remote value;

14. The system of claim 10, wherein value of the override datum is an attribute of the network topology.

15. The system of claim 14, wherein the attribute of the network topology comprises an attribute of a configured network topology prior to deployment of the configured network topology.

16. The system of claim 14, wherein the attribute of the network topology comprises an attribute of a reconfigured network topology prior to deployment of the reconfigured network topology.

17. The system of claim 10, further comprising, the processor provides the override datum to a plurality of networked components each with their respective datum.

18. The system of claim 10, wherein the processor provides the networked component with a configuration script that, that comprises the override datum.

19. The system of claim 10, wherein the processor is external to the network.

20. A method, comprising:
configuring a network determined by a topology, the topology being determined by a networked component, the networked component determining a telecommunications service provided by the network topology and, wherein the topology is determined by a datum having a seed value;
providing, an override datum to the networked component; and
upon receiving the override datum, replacing the value of the datum with the value of the override datum and providing the telecommunications service utilizing a reconfigured network topology of the network as determined by the present value of the datum.
